(19) United States
(12) Patent Application Publication
(10) Pub. No.: US 2015/0375491 A1
(43) Pub. Date: Dec. 31, 2015

(54) APPARATUS AND METHOD FOR PRODUCING A LAMINATE

(71) Applicant: GROUP RHODES LIMITED, Wakefield Yorkshire (GB)

(72) Inventors: Philip MCDONALD, Yorkshire (GB); Professor Graham COCKERHAM, Yorkshire (GB); Barry RICHARDSON, Yorkshire (GB); Gordon GREEN, Yorkshire (GB)

(21) Appl. No.: 14/767,656

(22) PCT Filed: Feb. 12, 2014
(86) PCT No.: PCT/GB2014/050402

§ 371 Date: Aug. 13, 2015

(30) Foreign Application Priority Data
Feb. 13, 2013 (GB) 1302511.9
Dec. 11, 2013 (GB) 1321924.1

(51) Int. Cl. B32B 37/28; B32B 37/10; B32B 37/00

(52) U.S. Cl. CPC B32B 37/28; B32B 37/0053; B32B 37/10

(57) ABSTRACT

An apparatus (100) for forming a laminate of pre-preg composite material comprises supply means (200) to supply pre-preg strip (400) to a stationary mandrel (300). The pre-preg strip (400) is formed into a tube (410) on the mandrel (300), and is driven to both rotate relative to the mandrel and to move axially along the mandrel. In this way it can be dispensed from an end of the mandrel (300) and formed in to a further pre-preg strip (420) with off-axis fibres.

### FIELD OF INVENTION

The invention relates to apparatus and a method for forming a laminate from composite material, such as glass fibre reinforced polymer (GFRP) and carbon fibre reinforced composite (CFC). In particular, the invention relates to forming laminates which comprise one or more off-axis plies, wherein the laminates are formed from pre-impregnated (pre-preg) material.

### BACKGROUND OF THE INVENTION

There is an increasing demand for components which are fabricated from composite materials such as GFRP and CFC. This is due to the excellent strength to weight ratio of these composites when compared to metal equivalents, and their potential for use in the automotive and defence industries.

Composite material is in general formed as a laminate, which comprises a plurality of individual plies that are sandwiched together, wherein the plies comprise a fibre and matrix component. To optimise the mechanical properties of the laminate it is desirable to have the fibres aligned at a range of angles, for instance 0°, 90°, +45°, −45°. These laminates are commonly hand laid and cured in an autoclave. This process does not lend itself to large scale manufacturing.

Apparatus for forming laminates with off-axis plies are known. For example, WO 2008/057146 discloses apparatus for producing a two layer off-axis composite material that has fibres at ±5°. In more detail the apparatus of WO 2008/057146 is arranged such that pre-preg strips are dispensed from a plurality of supply rolls that are positioned on two application wheels. The application wheels are operable to counter rotate with respect to each other about a stationary mandrel. The pre-preg strips are wrapped around the mandrel, upon which they are pressed by rollers to form a tube. Thereafter, the tube is slid off the mandrel and slit, then opened to form a strip. The application wheels could be considered to be complicated and require precise alignment to achieve the desired fibre angle. Furthermore, the apparatus does not enable the formation of a laminate which comprises the off-axis plies and other orientations, such as 90° and 45°.

An object of the present invention is to provide apparatus for forming a laminate with off-axis plies which overcomes one of the above or other problems. More specifically, an object of the present invention is to provide apparatus for forming a laminate with off-axis plies which is less complex.

### SUMMARY OF THE INVENTION

According to a first aspect of the present invention there is provided apparatus to form off-axis composite material, the apparatus comprising:

a supply means to supply a strip of composite material, the strip comprising a matrix and a plurality of fibres, which are aligned to each other;

a stationary mandrel arranged to receive a portion of the strip from the supply means, the mandrel and supply means being arranged such that the strip is supplied to the mandrel with the fibres orientated off-axis to an elongate axis of the mandrel,

characterised in that a drive means is configured to drive the received strip to rotate about the mandrel, and to move axially along the elongate axis of the mandrel such that the strip forms a tube on the mandrel, the mandrel being configured to dispense the tube from an end of the mandrel such that the dispensed tube when pressed into a further strip or sheet has fibres which have an orientation that is off-axis in relation to the length of the further strip or sheet.

Preferably, the strip of composite material is a pre-preg strip.

Alternatively, the strip of composite material is any continuous fibre plastics material.

Alternatively, the strip of composite material is any long fibre plastics material.

Preferably, the drive means is arranged to engage a surface of the tube on the mandrel. Preferably, the drive means comprises a belt arranged to grip a portion of the tube, such that movement of the belt causes the tube to be moved relative the mandrel by the belt.

Preferably, the drive means further comprises a motor arranged to drive the belt, preferably via a gear assembly. Preferably, at least a portion of the belt extends between a first and second pulley, wherein the belt is arranged to engage the pre-preg tube between the first and second pulley. Preferably, a position of one or both of the first and second pulleys is adjustable such that the portion of the pre-preg tube which is engaged by the belt is adjustable, preferably to adjust the extent to which the belt extends around the mandrel, and/or the angle of the belt relative the elongate axis of the mandrel. Optionally, the drive means further comprises a flange which is operable to prevent the rotational and axial motion of the tube on the mandrel from disengaging the belt from at least one of the first and second pulleys.

Preferably, the supply means comprises a roll of composite material which is arranged to rotate relative a stationary support, preferably about an axis of rotation. Preferably, the axis of rotation is inclined to the elongate axis of the mandrel. Preferably, the stationary support is constrainable to the ground.

Preferably, the supply means is operatively connected to a second drive means, which is operable to drive the roll to rotate. Preferably, the second drive means comprises a motor arranged to drive the roll preferably via a gear assembly.

Preferably, the first and second drive means are controlled by a control unit. Preferably, the control unit is configured to actuate both of the first and second drive means to drive simultaneously. Preferably, the control unit is configured to actuate both of the first and second drive means to desist drive simultaneously.

Preferably, the composite material comprises unidirectional fibres in an uncured resin matrix. Preferably, the fibres of the composite material comprise carbon fibres or glass fibres. Preferably, the matrix of the pre-preg material comprises one or more of the following materials: Polypropylene, PA6, PEEK and other thermoplastic materials.

Optionally, the fibres of the supplied strip of material of the supply means are aligned substantially to the length of the strip.

Alternatively, the fibres of the supplied strip of material are aligned substantially perpendicular to the length of the strip.

Preferably, the angle at which the fibres of the pre preg strip are supplied relative the elongate axis of the mandrel is between 5° to 85°. More preferably, it is between 30° to 60°. More preferably, it is about 45°. Preferably, a position of the stationary support is adjustable such that the angle at which the fibres are supplied relative the elongate axis of the mandrel is adjustable, to thereby adjust the angle of the fibres in the further strip dispensed from the mandrel.

Preferably, the off-axis composite material comprises a lay-up being defined as a sandwich structure comprising a plurality of plies of composite strip or sheet.

Preferably, the strip or sheet dispensed from the mandrel comprises two plies, wherein the angle of the fibres in the first ply relative to a longitudinal axis of the mandrel is equal and opposite to the angle of the fibres in the second ply relative to a longitudinal axis of the mandrel. More preferably, the angle in the first ply is between 5°-85° with respect to a length direction of the strip (or a longitudinal axis of the mandrel), and the angle of the fibres in the second ply is between −5° to −85° with respect to a length direction of the strip or sheet (or a longitudinal axis of the mandrel). More preferably, it is about 45° and −45°. More preferably, it is about 30° and +30°.

Preferably, the supply means and the mandrel are configured such that the strip is wrapped around the mandrel to define the tube, preferably such a supplied portion of strip overlaps an adjacent portion of strip which is already received on the mandrel to define an overlap region. Preferably, the overlap region is about 10mm across the width of the strip, or about 0.5%-5% of the width of the strip. More preferably it is about 11 mm.

Preferably, the apparatus further comprises a welding element arranged to join a portion of the strip once received on the mandrel to an adjacent portion of strip on the mandrel to thereby form the tube. Preferably, the welding element is arranged to join the strip at the overlap region.

Preferably, the welding element comprises a hot air welder. Preferably, the apparatus further comprises a guide element arranged proximate the welding element to ensure the adjacent portions of strip are aligned prior to welding, preferably with the correct overlap.

Preferably, the apparatus further comprises a pressing element arranged to press the strip once received on the mandrel. Preferably, the pressing element is arranged proximate the welding element, preferably such that the adjacent portions of strip are pressed into alignment prior to welding and/or preferably such that the adjacent portions of strip are pressed downstream of the weld.

Optionally, the pressing element comprises a first roller disposed to press the overlap region against the surface of the mandrel.

Alternatively, the pressing element comprises a first roller disposed to press the overlap region against a second roller, wherein the second roller is disposed beneath the surface of the mandrel. Preferably, the mandrel comprises a hollow portion for housing the second roller.

Preferably, the apparatus is configured such that the pre-preg strip is wrapped around the mandrel to form a continuous tube on an outer surface of the mandrel. Preferably, the tube is a single ply thick.

Preferably, an outer surface of the mandrel is substantially cylindrical. Preferably, the mandrel is between 2 and 5 metres in length. More preferably, it is about 3.6 metres.

Preferably, the apparatus further comprises a heating element which is disposed proximate the supply means, which is operable to soften the strip once dispensed from the supply means.

Preferably, the mandrel comprises a receiving section for receiving the strip.

The mandrel may comprise a cutting section for cutting the tube into portions of a given length.

Preferably the mandrel comprises a dispensing section for dispensing the tube. Preferably, the dispensing section is positioned at a first end of the mandrel, and comprises a tapered section, the taper being arranged such that the diameter of the mandrel is narrower at its tip. Preferably, the receiving section is disposed between the first end and a second end of the mandrel.

Preferably the cutting section comprises a cutting ring disposed around the mandrel and preferably operable to move along an axis substantially identical to the axis of the tube.

Preferably the cutting ring is operable to move between a cutting start position and a cutting end position.

Preferably the cutting ring is operable to move from the cutting start position to the cutting end position to match an axial motion of the tube, whilst performing a cutting operation. Preferably the ring-shaped cutting unit is operable to move at a speed substantially identical to the axial motion of the tube whilst performing the cutting operation.

Preferably the cutting ring is operable to return to the cutting start position from the cutting end position whilst performing a return operation, such that the ring-shaped cutting unit is operable to start another cutting operation a fixed distance from the first end of the mandrel. Optionally, the fixed distance is substantially equal to the width of the further sheet when compressed, so that a square-shaped further sheet may be formed. The fixed distance may be a direct result of one or more of the number of cutters, the mandrel diameter and the rotational speed of the tube being performed.

Preferably the cutting ring comprises one or more cutter heads. Preferably the cutting ring engages the cutter heads, thereby cutting the tube whilst performing the cutting operation. Preferably the cutting ring disengages the cutter heads whilst performing a return operation.

Preferably the cutter head comprises one or more rotatable cutting wheels disposed to cut in a direction substantially transverse to the longitudinal axis of the tube.

Preferably the or each rotatable cutting wheel is disposed so that the rotation of the tube forces the or each rotatable cutting wheel into the tube, thereby cutting the tube.

Alternatively, the cutting ring comprises one or more laser cutting elements. Alternatively, the cutting ring comprises one or more diamond-tipped cutting elements.

Preferably, the cut portions of the tube are propelled from the cutting section by the motion of the uncut tube along the mandrel.

Preferably, the drive means is disposed between the dispensing section and the welding element.

Preferably, the mandrel is supported at a second end in a cantilevered arrangement with respect to the ground.

Preferably, the apparatus further comprises a receiving means, which is operable to receive the tube once dispensed from the dispensing section of the mandrel.

Alternatively, the apparatus further comprises a flattening section for flattening the portions of tube dispensed by the cutting section.

Preferably, the receiving means comprises a roll which is rotatably mounted to a support structure. Preferably, the roll is rotatable about a rotational axis, which is orientated substantially perpendicular to the elongate axis of the mandrel. Preferably, the roll is rotatable by means of a third drive means, preferably, via a gear assembly, wherein the drive means is operable to effect rotation of the roll such that the tube is urged off the dispensing section and on to the roller of the receiving means.

Preferably, the control unit is configured to control the third drive means in accordance with the first and second drive means such that the dispensed strip is urged off the dispensing section and on to the roller of the receiving means.

Preferably, support structure is configured to enable rotation of the roller receiving means about an axis which is substantially aligned to the elongate axis of the mandrel. Preferably, the support structure is rotatable by means of a fourth drive means, preferably, via a gear assembly, wherein the fourth drive means is operable to effect rotation of the support structure such that it rotates with the tube to prevent twisting of the tube when dispensed from the dispensing section of the mandrel. Preferably, the control unit controls the fourth drive means such that the support structure rotates at substantially the same rate as the tube on the mandrel.

Preferably, the support structure comprises a drum arranged to rotate within a stationary support, wherein the roll is connected to the drum at a first and second point, such that the rotational axis of the roll extends across the diameter of the drum.

Preferably, a cutting element is disposed between the dispensing section of the mandrel and receiving roller, which is operable to cut the tube at a first and second point along a line parallel to the axis of rotation of the drum, wherein the first and second point are diametrically opposed to each other.

Preferably, an opening element is disposed between the cutting element and receiving roller, wherein the opening element comprises guide means, which are configured to guide the cut tube to a substantially flat strip prior to it being received by the receiving means.

Preferably, the opening element and cutting element are disposed on the drum such that they rotate with the drum.

Preferably, a pressing element is disposed between the dispensing section and receiving means, and preferably upstream and/or downstream of the cutting element which is configured to press the tube dispensed from the dispensing section prior to it being received by the receiving roller. Preferably, the pressing element is disposed on the drum such that it rotates with the drum.

Preferably, the flattening section comprises a plurality of pairs of rollers. Preferably, the rollers in each pair are disposed at opposite sides of an elongate axis of the tube,

Preferably, the rollers are aligned transversely with respect to the axis of the tube. Preferably, the rollers in each pair are positioned in the same vertical longitudinal plane. Preferably, the plurality of pairs of rollers are positioned successively from a receiving end, closest to the cutting section, and a dispensing end, furthest from the cutting section.

Preferably, the distance between the rollers in each of the plurality of pairs of rollers decreases successively from the receiving end to the dispensing end, so that a tube propelled through the flattening section is progressively flattened, so that a sheet comprising two plies, wherein the angle of the fibres in the first ply is equal and opposite to the angle of the fibres in the second ply, is formed.

Preferably, the axial motion of the tube propels the tube through the flattening section, forcing the tube to be flattened by each of the plurality of pairs of rollers.

Preferably, the outer surface of the mandrel comprises an outer surface which permits relative movement of the tube on the mandrel, preferably the outer surface comprises Teflon coating.

Preferably, the off-axis strip dispensed by the mandrel comprises a 2 ply strip with a first strip having fibres which are positively angled with respect to the length of the strip, and a second strip having fibres which are negatively angled with respect to the length of the strip.

Preferably, the apparatus comprises a bonding section, operable to bond together a plurality of sheets of composite material dispensed by the flattening section to form a single multi-ply sheet. Preferably the material bonded comprises both 2-ply off-axis composite material dispensed by the flattening section and on-axis composite material.

Preferably, the plies are arranged so that the orientation of the fibres in the plies from a top ply to a middle ply is identical to the orientation of the fibres in the plies from a bottom ply to a middle ply.

Preferably the material bonded has 3 layers, whereby the central layer is a single ply of on-axis composite material and the other layers are 2-ply off-axis composite material dispensed from the flattening section,

Alternatively, any odd number of layers may be bonded, whereby the orientation of the fibres in the plies from a top ply to a middle ply is identical to the orientation of the fibres in the plies from a bottom ply to a middle ply.

Preferably, the material is bonded by ultrasonic welding. Preferably, the material is bonded at a plurality of bond points. Preferably, the bond points are located approximately ¼ of the width away from the edge and the top edge.

According to a second aspect of the invention there is provided a method of forming off-axis composite material, the method comprising:

supplying a strip of composite material from a supply means to a stationary mandrel, the strip comprising a matrix and a plurality of fibres, which are aligned to each other, wherein the mandrel and supply means are arranged such that the pre-preg strip is supplied to the mandrel with the fibres orientated off-axis to an elongate axis of the mandrel,

characterised in that the method comprises a step of using a drive means to drive the received strip to rotate about the mandrel, and to move axially along the elongate axis of the mandrel such that the pre-preg strip forms a tube on the mandrel;

and a step of dispensing the tube from an end of the mandrel such that the dispensed tube when pressed into a strip or sheet has fibres which have an orientation that is off-axis in relation to the length of the strip or sheet.

Preferably, prior to supplying the strip to the mandrel, the method includes a step of joining a plurality of strips pre-preg material to form a wider strip of material, the wider strip of material being dispensed by the supply means. Preferably, the method includes a step of joining a first strip of material to a second strip of pre-preg material to form a wider strip of material.

Preferably, the first strip is dispensed from a roll which is rotatably mounted on a first stationary support, and the second strip is dispensed from a roll which is rotatably mounted on a second stationary support, wherein the first and second strips are fed adjacent to each other into a pressing element, preferably, such that the first and second strips overlap by about 5 mm-20 mm. Preferably, the pressing element comprises a plurality of rollers which are configured to press the first and second strip together at the overlap. Preferably, a welding element is arranged to weld the first and second strip together at the overlap, preferably the welding element is positioned upstream of and/or downstream of and/or between the rollers of the pressing element.

Preferably, the method includes a step of wrapping the strip around the mandrel to form a tube of strip.

Preferably, the method includes a step of joining a portion of the strip once received on the mandrel to an adjacent portion of strip already on the mandrel by means of a welding element.

Preferably, the method includes a step of dispensing the tube from a dispensing section of the mandrel, wherein the dispensing section comprises a tapered section, the taper being arranged such that the diameter of the mandrel is narrower at its tip.

Preferably, the method includes a step of collecting the dispensed strip as a roll on a receiving means, the roll having an axis of rotation which is oriented substantially perpendicular to the axis of rotation of the mandrel.

Alternatively, the method includes a step of cutting the tube into sections using a cutting section. Alternatively, the method includes a step of flattening the cut sections of tube to form sheets.

Preferably, the step of collecting the dispensed strip includes a step of rotating the roll about an axis aligned to the elongate axis of the mandrel by means of a rotatable support structure.

Preferably, the method further comprises a step of laying one or more further strips with the strip of the roller of the receiving means to form a composite lay-up, the method comprising:

arranging a roll of the or each further strip adjacent a roll from the receiving roller, such that the strip from the receiving roller and the or each further strip when dispensed are laid together when received by a pressing element, the pressing element preferably comprising a plurality of rollers. Preferably, the or each further strip comprises strip material arranged with the fibres orientated differently to the fibres of the strip from the receiving roller. Preferably, the method further includes a step of part consolidating the strips together by means of a welding element, which is disposed downstream of the pressing element.

Alternatively, the method further comprises a step of bonding a plurality of sheets of composite material, the method comprising:

arranging a plurality of sheets dispensed by the flattening section into layers,

bonding the layers together using ultrasonic welding.

Preferably the material bonded comprises both 2-ply off-axis composite material dispensed by the flattening section and on-axis composite material. Preferably, the plies are arranged so that the orientation of the fibres in the plies from a top ply to a middle ply is identical to the orientation of the fibres in the plies from a bottom ply to a middle ply.

Preferably the material bonded has 3 layers, whereby the central layer is a single ply of on-axis composite material and the other layers are 2-ply off-axis composite material dispensed from the flattening section,

Alternatively, any odd number of layers may be bonded, whereby the orientation of the fibres in the plies from a top ply to a middle ply is identical to the orientation of the fibres in the plies from a bottom ply to a middle ply.

Preferably, the material is bonded at a plurality of bond points. Preferably, the bond points are located short distance from an edge or corner of the material. Preferably, there are four bond points, each located proximate to a corner of the material.

All of the features described herein may be combined with any of the above aspects, in any combination.

### BRIEF DESCRIPTION OF THE DRAWINGS

For a better understanding of the invention, and to show how embodiments of the same may be carried into effect, reference will now be made, by way of example, to the accompanying diagrammatic drawings in which:

FIG. 1 shows a perspective view of apparatus for forming a laminate of off-axis composite material according to an exemplary embodiment of the invention;

FIG. 2 shows a perspective view of a guide element of the apparatus of FIG. 1;

FIG. 3 shows a perspective view of a drive means of the apparatus of FIG. 1;

FIG. 4 shows a perspective view of a receiving means and rotary support structure of the apparatus of FIG. 1;

FIG. 5 shows a perspective view of a cutting element and opening element of the apparatus of FIG. 1;

FIG. 6 shows a perspective view of apparatus for joining strips of composite material;

FIG. 7 shows a perspective view of apparatus for forming a lay-up of composite material;

FIG. 8 is a schematic perspective view of an alternative cutting section of the apparatus;

FIG. 9 is a schematic end view of the alternative cutting section; and

FIG. 10 is a schematic side view of an embodiment of the apparatus incorporating the alternative cutting section.

### DETAILED DESCRIPTION OF THE EXEMPLARY EMBODIMENTS

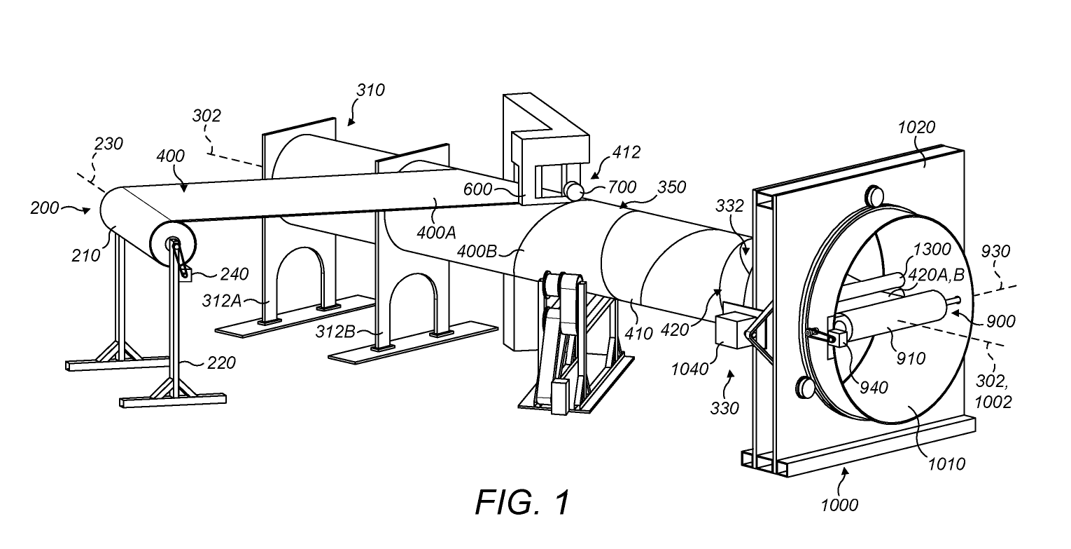

FIG. 1 shows an exemplary embodiment of apparatus 100 for forming a laminate of pre-preg composite material. The apparatus comprises supply means 200 to supply pre-preg strip 400 to a stationary mandrel 300. The pre-preg strip 400 is formed into a tube 410 on the mandrel 300, and is driven to both rotate relative to the mandrel and to move axially along the mandrel. In this way it can be dispensed from an end of the mandrel 300 and formed in to a further pre-preg strip 420 with off-axis fibres, as will be discussed in more detail below.

Firstly considering the supply means 200, in this example the supply means 200 comprises a roll 210 of the pre-preg strip 400, which is rotatably mounted to a support 220. It will be appreciated that other configurations of supply means are possible, for instance, the pre-preg strip 400 may be directly fed to the mandrel 300 in strip form from a conveyor, thus obviating the need for an intermediate roll 210. However, referring back to the present configuration, the roll 210 is connected to the support 220 at its ends, and is operable to rotate about an axis of rotation 230. The support 220 remains stationary in use, however the orientation of the axis of rotation 230 can be adjusted relative to an elongate axis of the mandrel 300. Such adjustment is used to change the orientation of the fibres on the tube 410 and strip 420 as will be discussed in more detail below.

In one example, rotation of the pre-preg tube 410 about the mandrel 300 causes the pre-preg strip 400 to be pulled from the roll 210, such that it is dispensed onto the mandrel without the need for the drive means 240 as discussed below. However, in this example, the roll 210 is operatively connected to drive means 240, which is operable to drive the roll 210 to rotate. In more detail, the drive means 240 comprise a motor (not shown), which is arranged to drive the roll 210 via a gear assembly (not shown). The drive means 240 is optionally configured to drive the roll 210 upon actuation of separate drive means 800 which is operable to cause rotation tube 410 on the mandrel 300. Such an arrangement is achieved by means of a control unit 500 (not shown), which is connected to and controls operation of both the drive means 800 and 240. An advantage of the drive means 240 is that it reduces the tensile force on the pre-preg strip 210, in comparison to an arrangement where the pre-preg strip 210 is dispensed from the roll 220 solely by force provided by rotation of tube 410 on the mandrel 300. The control unit 500 is also configured to control the drive means 240 to prevent excessive rotation of the roll 210 once rotation of the tube 410 has been stopped and/or reduced by the drive means 800. In this way excessive unrolling of the roll 210 is prevented.

The rate of rotation of the roll 210 is controlled by the control unit 500 (via the drive means 240) such that a constant feed rate of pre-preg strip 400 is maintained. For instance, as the amount of pre-preg strip 400 on the roll 210 decreases, the diameter at the periphery of the roll is decreased, accordingly, to compensate, the control unit 500 (not shown) increases the rate of rotation of the roll.

Now considering the mandrel 300 in more detail. The mandrel 300 is elongate about an axis 302 and has a proximal end 310 and a distal end 330. Between the proximal and distal ends 310, 330 there exists a cylindrical forming portion 350 for receiving the pre-preg strip 400, and upon which the tube 410 is formed.

At the proximal end 310 the mandrel 300 is supported by structural supports 312A, 312B, which maintain the mandrel 300 in a fixed position that is substantially horizontal with respect to the ground.

At the distal end 330 the mandrel 300 comprises a dispensing portion 332 that has a taper arranged to taper from the diameter of the forming portion 350 to a smaller diameter. In this embodiment the outer surface tapers such that it is inclined at about 20° to the axis of symmetry of the mandrel. However, it will be appreciated that other suitable angles may be used.

The pre-preg strip 400 is supplied to the mandrel 300 such that it is wrapped around the forming portion 350 of the mandrel to form the tube 410. In more detail, the pre-preg strip 400 is wrapped around the mandrel such that a subsequently laid portion 400A is partially overlaid on top of, and along an edge of a portion 400B of the pre-preg strip 400 which has already been laid on the forming portion. Accordingly, an overlap region 412 is created, which is typically 5-20 mm in width, however it will be appreciated that different quantities of overlap may be used depending on the overall width of the pre-preg strip 400 and size of the mandrel 300.

In one example, the forming surface 350 of the mandrel 300 comprises a non-stick coating which permits relative movement of the pre-preg tube 410 on the mandrel 300. An example of such a coating is Teflon.

A welding element 600 is arranged to weld the portions 400A and 400B together at the overlap region 412. In more detail the welding element comprises a hot air welder operable to supply hot air which is about 650° C. to the overlap region 412. The hot air causes the portions 400A and 400B to be consolidated/partly consolidated together.

A pressing element 700 is disposed proximate the welding element 600 and is operable to press the overlap region 412 such that it is correctly aligned/consolidated. In this example the pressing element comprises a first roller 710A, which is positioned external the mandrel 300, and a second roller 710B (not shown), which is positioned within the mandrel 300. The rollers 710A, 7108 are orientated such that their axis of rotation is substantially perpendicular to the edge of the overlap region 412, and are orientated such that the overlap region 412 is fed between them as the tube 410 is rotated on the mandrel. It will be appreciated that in another example the pressing element 700 may comprise only the first roller 710A which is arranged to press the overlap region 412 against the forming surface 350 of the mandrel 300.

In this example the pressing element 700 is arranged to press the overlap region 412 after it has been welded, hence downstream of the weld. However, in other examples it will be appreciated that the pressing element 700 can be additionally or alternatively positioned to act on a portion of the overlap region 412 which is upstream of the weld.

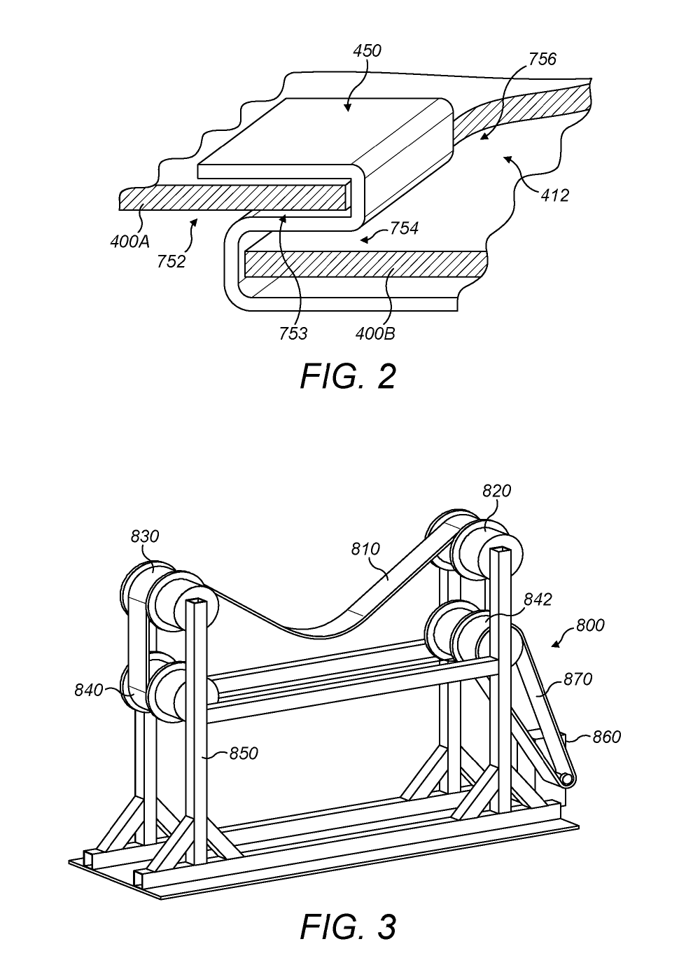

FIG. 2 shows a guide element 750 which is designed to ensure the pre-preg strip 400 is correctly aligned at the overlap region 412 prior to welding. In more detail the guide element comprises an ‘S’ shaped formation, with a first channel 752 for receiving the pre-preg strip 400A to be received on the mandrel 300, and a second channel 754 for receiving the pre-preg strip 400B which is already on the mandrel. As shown, the channels 752, 754 extend in opposed directions, and the first channel 752 is arranged with its inlet 752 aligned to the feed of strip from the supply means 200 to receive the pre-preg strip directly from it, whereas the inlet 755 of the second channel is aligned to receive the strip 400B as it rotates on the mandrel. Such an arrangement is achieved by connecting a portion of the second channel 754 to the mandrel. An advantage of the guide element is that the gap 756 between the channels 752, 754 allows hot air from the welder to travel between the strips 400A, 400B immediately after the strips exit the guide element 750. Such an arrangement improves the efficiency of the welding process.

As best seen in FIG. 3, a drive means 800 is arranged in operational proximity to the forming surface 350 of the mandrel 300 such that it can drive the tube 410 to rotate relative the mandrel 300, and drive the tube 410 to displace axially along the mandrel 300. In more detail, the drive means 800 comprises a first belt 810 which extends around a first pulley 820, a second pulley 830 a third pulley 840 and a fourth pulley 842, all of which are rotatably mounted to a stationary support 850. A motor 860, which is also attached to the stationary support 850, is arranged to drive the fourth pulley 842 via a second belt 870 and a gear assembly (not shown) such that the desired rotational speed is obtained. The first and second pulley 820, 830 are arranged such that the belt 810 both extends circumferentially around the forming portion 350 and partially extends along the elongate axis 302 of the mandrel 300. In this way, the belt 810 is operable to grip the tube 410 and drive it to both rotate about the elongate axis 310 of the mandrel and to move along the elongate axis 310 of the mandrel 300. Such driving of the tube 410 causes the pre-preg strip 400 to be dispensed from the supply means 200 and subsequently formed as part of the tube 410, as will be described in more detail below.

In this example and as best seen in FIG. 1 the belt 810 extends around a lower surface of the mandrel, however it will also be appreciated that the same effect can be achieved by arranging the belt to extend around the sides or top of the mandrel 300.

The position of first and second pulleys 820, 830 is adjustable by moving the stationary support 850, for instance in a height direction and also along the ground. In this way the angle at which the belt 810 grips the tube 410, and the extent to which the belt 810 grips the tube can be adjusted. Accordingly, the position of the fourth pulley 842 is also adjustable relative the stationary support 850 such that it can take up the slack in the belt 810 which occurs by adjustment of the positions of the first and second pulleys 820, 830.

Although an example of drive means 800 which has four pulleys has been shown, it will be appreciated that other configurations of drive means 800 are possible, for instance, the drive means 800 may be configured without a third pulley.

In the instance where the fibres are arranged such that they are aligned to the length of the strip, the stationery support 850 is positioned relative the mandrel 300 such that the belt 810 is aligned to the fibres in the composite material that forms the tube 410. However, it will be appreciated that in the instance where the fibres in the strip are normal to its length, the belt is perpendicular to the fibres.

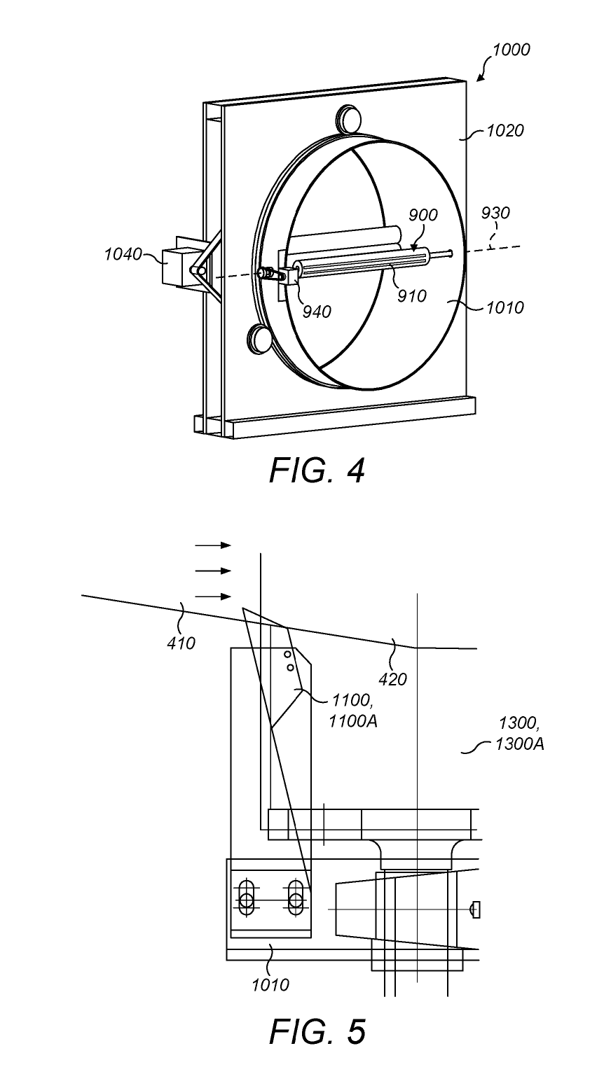

As best seen in FIGS. 1 and 4 a receiving means 900 is disposed proximate the distal end 330 of the mandrel 300 and is arranged to receive the strip 420 once dispensed from the tapered dispensing portion 332 of the mandrel. In more detail, the receiving means 900 comprises a roll 910 of the pre-preg strip 420, which is rotatably mounted to a drum 1010 of a rotary support structure 1000, as will be discussed in more detail below. It will be appreciated that other configurations of receiving means are possible, for instance, the pre-preg strip 420 may be directly fed from the mandrel 300 to a conveyor, thus obviating the need for an intermediate roll 910. However, referring back to the present configuration, the roll 910 is connected to the drum 1010 at its ends, across the diameter of the drum, and is operable to rotate about an axis of rotation 930. The drum 1010 rotates about the elongate axis 302 of the mandrel in use, as will be discussed in more detail below, however during this rotation the axis of rotation 930 of the roll 910 remains substantially perpendicular to the elongate axis 302 of the mandrel 300.

The roll 910 is operatively connected to drive means 940, which is operable to drive the roll 910 to rotate. In more detail, the drive means 940 comprise a motor (not shown), which is arranged to drive the roll 910 via a gear assembly (not shown). The drive means 940 is optionally configured to drive the roll 910 upon actuation of the drive means 800 which is operable to cause rotation tube 410 on the mandrel 300. Such an arrangement is achieved by means of the control unit 500, which is connected to and controls operation of both the drive means 800 and 940. The control unit 500 is also configured to control the drive means 940 to prevent rotation of the roll 910 once rotation of the tube 410 has been stopped by the drive means 800. In this way excessive unrolling of the roll 910 is prevented.

The rate of rotation of the roll 910 is controlled by the control unit 500 (via the drive means 940) such that the roll 910 can receive the pre-preg strip 420 at a constant feed rate. For instance, as the amount of pre-preg strip 420 on the roll increases, the diameter at the periphery of the roll is increased, accordingly, to compensate, the control unit 500 decreases the rate of rotation of the roll.

A rotary support structure 1000 is arranged to house the receiving means 900. In more detail, the rotary support structure 1000 comprises a rotatable drum 1010 that is arranged to rotate within a stationary support 1020. The drum 1010 is arranged about an axis 1002 which is aligned to the elongate axis 302 of the mandrel.

The drum 1010 is operatively connected to drive means 1040, which is operable to drive the drum 1010 to rotate. In more detail, the drive means 1040 comprises a motor (not shown), which is arranged to drive the drum 1010 via a gear assembly (not shown). The drive means 1040 is optionally configured to drive the drum 1010 upon actuation of the drive means 800 (which is operable to cause rotation of the tube 410 on the mandrel 300). Such an arrangement is achieved by means of the control unit 500, which is connected to and controls operation of both the drive means 800 and 1040. The control unit 500 is also configured to control the drive means 1040 such that the drum 1010 rotates at the same rate as the tube 410 on the mandrel 300. In this way twisting of the tube 410 is prevented as it is transferred from the mandrel 300 to the receiving means 900.

As best seen in FIG. 5 a cutting element 1100 is disposed on the drum 1010, such that it rotates with the drum 1010, and is positioned between the dispensing section 332 of the mandrel 300 and the receiving means 900. The cutting element 1100 comprises two blades 1110A, 11108 (not shown) which are arranged to cut the pre-preg tube 410 into the strip 420. In more detail, the blades 1110 are positioned to be in line with the axis of rotation 930 of the receiving means 900, and are positioned symmetrically with respect to each other about the axis 1002 of rotation of the drum 1010. The blades are orientated such that the cutting portion is normal to and extends through the side of the tube 410. In this way, as the tube 410 is fed towards the receiving means 900 it is cut by both blades 1110A, 11108 along two lines which are parallel to the axis of rotation of the drum 302 and converted into two strips 420A, 420B.

An opening element 1200 is disposed on the drum 1010, such that it rotates with the drum 1010, and is positioned between the cutting element 1100 and the receiving means 900. The opening element 1200 comprises two guides 1210A, 1210B (not shown) which are arranged to guide the cut pre-preg tube 410 such that it is re-shaped into a substantially planer strip 420 that is suitable for being rolled on the roller 910 of the receiving means 900. In more detail, the guides 1210 are positioned to be in line with the axis of rotation 930 of the receiving means 900, and are positioned symmetrically with respect to each other about the axis 1002 of rotation of the drum 1010.

Notably, the diameter of the drum 1010 is greater that the diameter of the mandrel 300. Such an arrangement is to enable the tube 410 dispensed from the mandrel to be fully opened into the planer strips 420A, 420B within the drum 1010.

As best seen in FIGS. 1 and 5 a pressing element 1300 (not shown) may be disposed between the cutting element 1200 and the receiving means 900 and in addition or alternatively, further pressing elements may be positioned between the cutting element and dispensing portion 330 of the mandrel 300. The pressing element 1300 comprises two counter rotating rollers 1310A, 1310B (not shown) which are attached to the drum 1010 such that they rotate with the drum 1010. The rollers 1310A, 1310B arranged on either side of the cut pre-preg strip 420A 420B such that as the pre-preg strip 410 passes between the rollers 1310A, 1310B, it is pressed prior to it being received by the receiving roller 910.

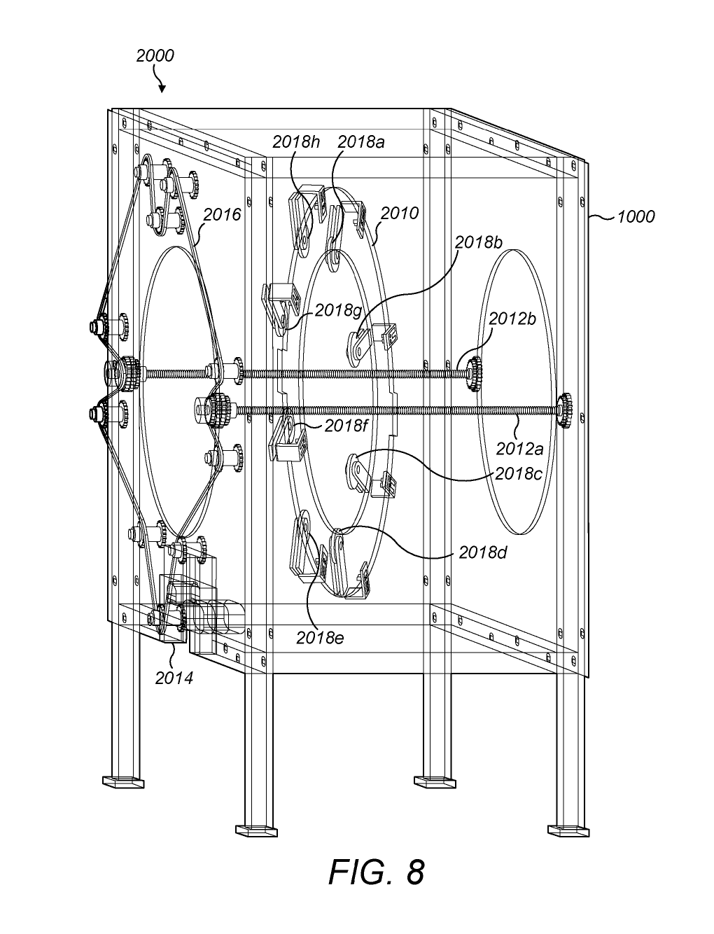

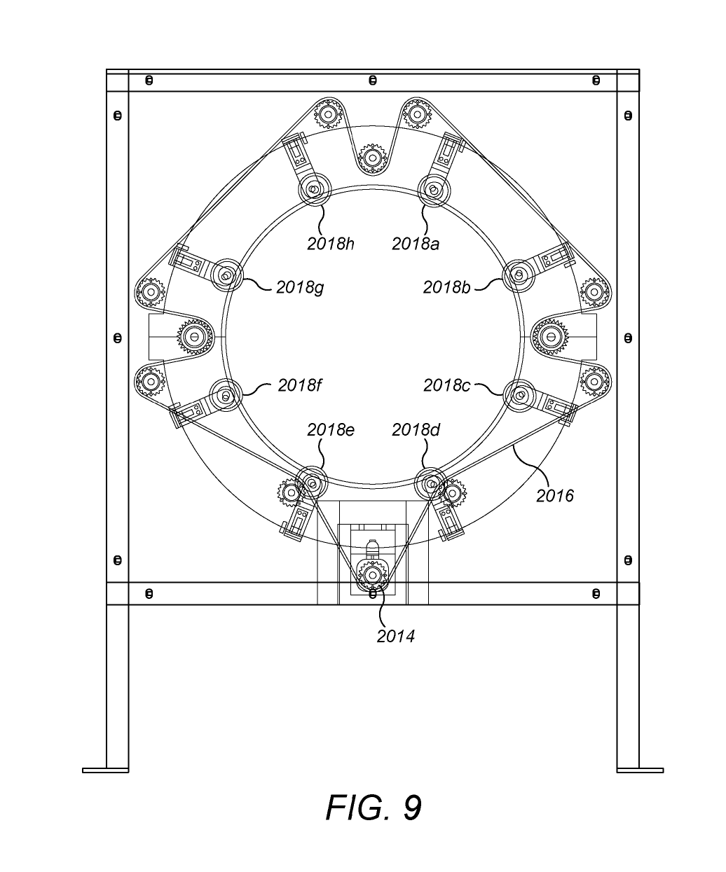

An alternative embodiment of the cutting section is shown in FIGS. 8, 9 and 10. The alternative cutting section shares the rotary support structure 1000 with the previous embodiment but has a different cutting means 2000 comprising a cutting ring 2010 mounted on lateral supports 2012a and 2012b. A motor 2014 drives a belt 2016 that drives the cutting ring 2010 along the lateral supports 2012 at a speed matching the progression of the tube 410 of pre-preg material. Cutter heads 2018a, b, c, d, e, f, g and h are located on the cutting ring 2010 and as can be seen in FIG. 9 protrude inwards of an inner periphery of the cutting ring to allow engagement with the tube 410 to allow cutting thereof. The belt 2016 may drive the engagement/disengagement of the cutter heads 2018a-h.

In order to cut the tube 410 perpendicular to its longitudinal axis it is necessary to move the cutting ring at the same speed as the tube 410 progresses along the mandrel. Matching of the speed of the motor 2014 to ensure progression of the cutting ring 2010 at the same speed as the tube 410 allows the position of the cut to remain fixed with respect to the longitudinal axis of the tube. Movement of the cutting ring 2010 around the longitudinal axis of the mandrel (and also the tube 410) allows the cutting heads 2018 to produce a cut whilst the tube 410 is formed and moved along the mandrel.

The cutting operation must be performed during the progression of the tube 420 from the right hand end of the lateral supports 2012a and 2012b shown in FIG. 8 to the left hand end of those supports. During this time the cutting ring 2010 is driven along the lateral supports 2012a and 2012b to perform the cutting. When the cutting has been finished then the cutting heads 2018 are disengaged and the cutting ring 2010 is returned to the right hand end of the lateral supports 2012 as shown in FIG. 8 for the cutting of another section of the tube 410.

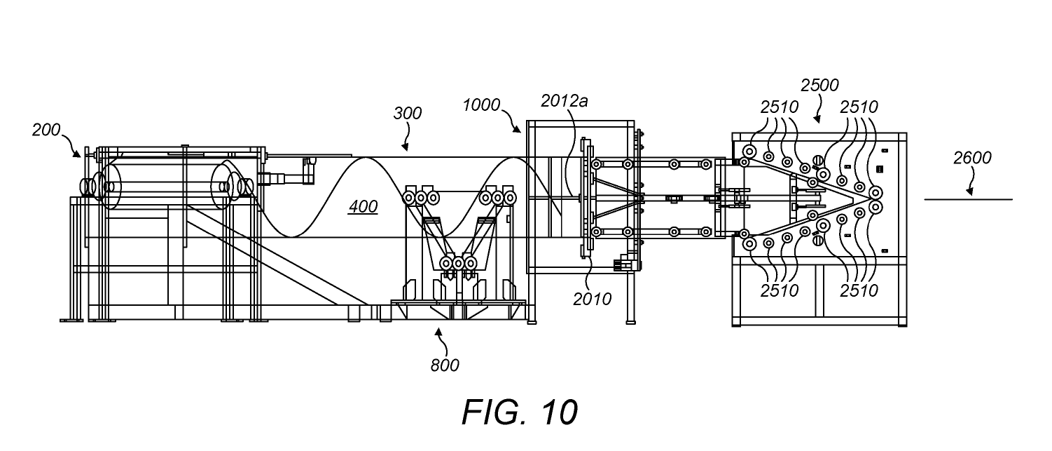

As the cut section of tube progresses out of the cutting means 2000 (on the left hand end as shown in FIG. 8) it proceeds to a flattening section 2500. The flattening section 2500 as shown in FIG. 10 provides a narrowing wedge-shaped space into which the cut section of tube 410 is pushed by the driving means 800. The flattening section 2500 comprises sets of rollers 2510 that are placed in a progressively narrowing formation to urge the cut tube shape into a flattened two-ply sheet 2600 formed of the pre-preg strip 400. It will be understood that the flattened two-ply sheet 2600 consists of a first layer having an off-axis alignment with fibres aligned at a symmetrically negative angle to the longitudinal axis of the mandrel. The two layers may be separated and used in creating a multi-ply material, perhaps with an on-axis central layer of the material with the off-axis layers referred to above located on either face of the on-axis material.

Based on the length of the tube 410 that is cut by the cutting means 2000, rectangular or square sections of the off-axis material will be produced by the machine described herein. These off-axis layers of material can be laid up with on-axis layers and also layers of varying degrees of off-axis alignment to produce a material that has excellent strength properties in multiple directions and, for example, has a significantly lower weight than steel, but with corresponding or improved strength characteristics.

It is noted that multi-ply sheets in which the orientation of the fibres in the plies from a top ply to a middle ply is identical to the orientation of the fibres in the plies from a bottom ply to a middle ply have been found to have excellent strength characteristics.

For example, a 3 layer/5 ply material may be formed, whereby the central layer is a single ply of on-axis composite material and the other layers are 2-ply off-axis composite material dispensed from the flattening section 2500, It will be understood that any odd number of layers may be bonded in a similar manner to produce very strong material.

The off-axis panels can suitably be supplied in 1 m² sections, either in a single off-axis layer or in multiple layers as described above. The layers described herein may be welded together with suitable ultrasonic welding or other forms of welding as appropriate to the material from which the tube 410 is formed.

In one example, the material is ultrasonically welded at four bond points, each located towards a corner of the sheet, and approximately ¼ of the width of the sheet away from the edges of the sheet.

Considering the material of the pre-preg strip 400, this may be any formation of pre-preg material which is known in the art. In more detail, the material comprises unidirectional fibres in an uncured resin matrix. The fibres are typically carbon fibres or glass fibres, and the matrix typically comprises one or more of the following materials; a thermoplastic

The fibres are orientated such that they are aligned in the width direction of the strip 400 (for instance, the fibres are parallel to the axis of rotation 230 of the roll 210, when rolled), however it will be appreciated that the fibres can also be aligned along the length direction of the strip.

Since the support 220 is positioned such that the axis of rotation 230 of the roll 210 of strip 400 is an angle to the elongate axis 302 of the mandrel 300, the fibres in the strip 400 are fed at an angle to the elongate axis 302 of the mandrel 300, typically this angle is about 60°. Therefore, as the strip 400 is formed into a tube 410 on the mandrel, it will be appreciated that the fibres are arranged to form a helix.

Accordingly, as the tube 410 is cut and pressed flat to form the 2 ply strip 420 the fibres in the first ply 420A are positively angled with respect to the length of the strip, and the fibres in the second ply 420B are negatively angled with respect to the length of the strip. In this way, the roll 910 of the receiving means collects a two ply thick strip with an angled ply orientation. It will be appreciated that as the angle of the support 220 is adjusted to change the alignment of the axis of rotation 230 with the elongate axis 302, the angle of the fibres in the plies 420A, 420B is adjusted. Generally, the apparatus is configured to produce a strip with fibres which are +45/−45, or +30/−90 although it will be appreciated that a range of angles are possible.

A method of using the apparatus 100 will now be described with reference to the above description. The pre-preg strip 400 is supplied from the roll 210 of the supply means 200 to the forming section 350 of the mandrel 300. This is achieved by simultaneous actuation of both the drive means 230 of the supply means 200, and of the drive means 800 proximate the mandrel 300. The pre-preg strip 400 is then wrapped around the mandrel 300 to form a tube 410. The tube is fixed together at the overlap region 412 by the welding element 600 and pressing element 700. Downstream, the drive means 800 grips the tube 410 and causes it to rotate around the mandrel and to move axially along the mandrel such that it is dispensed from the mandrel 300. Thereafter, the tube 410 is cut by the cutting element 1100 and opened into a strip 420 by the opening element 1200. The strip 420 is then collected as a roll 910 on the receiving means 900.

Once the roll 910 becomes full, the drive means 230, 800, 940 and 1040 are stopped. The strip 420 is then cut proximate the roll 910 to enable removal of the roll. The roll 910 is then replaced and the strip 420 is attached to the new roll. The drive means 230, 800 and 1000 can then be re-started and the forming process continued.

Once the roll 210 of the supply means 200 becomes empty, the drive means are stopped and the old roll 210 is replaced by a new roll and the strip of the new roll fastened to the end of the strip of the old roll.

To initiate the process described in FIG. 1, firstly a strip from the supply means 200 is manually placed on the mandrel 300. The strip is then manually wrapped around the mandrel 300 to form the tube 410. The tube is manually rotated on the mandrel 300 until it engages with the drive means 800. Thereafter, the drive means is used to rotate the tube until it is dispensed from the mandrel 300. The dispensed tube 410 is then manually guided through the cutting element 1100 and pressing element 1300 and attached to the receiving means 900. Thereafter, the process can be automated using the control unit 500 and associated drive means: 240, 800, 940, 1040.

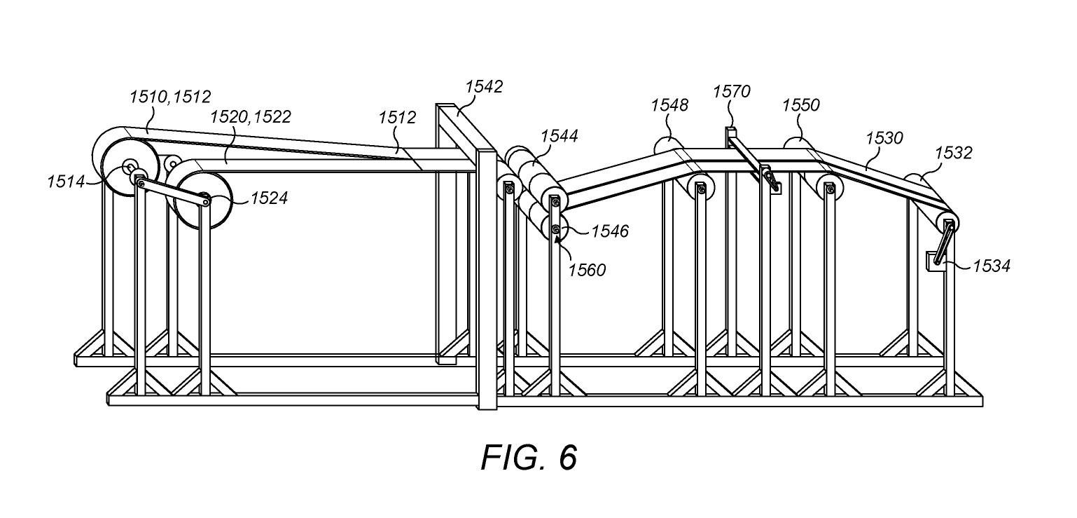

Prior to the process described in the above and in FIG. 1, a plurality of strips can be formed together by the process illustrated in FIG. 6, as will be discussed in more detail below.

Accordingly, with reference to FIG. 6a, and as part of the process 1500, a first strip 1510 is joined to a second strip 1520, to form a wider third strip 1530. In more detail, the first strip 1510 is arranged on a first roll 1512, and the second strip 1520 is arranged on a second roll 1522. An axis of rotation of the first roll 1514, and an axis of rotation of the second roll 1524 are aligned to each other, and are arranged such that the axis 1524 is forward of and below the axis 1514. In this way, when both strips 1510, 1520 are fed into a pressing element 1540, the strip 1510 is positioned above and can partially overlap the strip 1520 to create an overlap region 1512 which extends along the edges of the strips.

The pressing element 1540 comprises a plurality of rollers 1542, 1544, 1546 which are arranged to guide and press the strips together at the overlap region 1512. In more detail, the roller 1542 is arranged to receive the strips 1510, 1520 and guide them between the rollers 1544, 1546, which are driven to counter rotate and provide a pressing force by the drive means 1560.

Downstream, further rollers 1548 and 1550 receive the strips 1510, 1520 and are arranged on either side of a welding element 1570. The welding element 1570 acts to weld the strips 1510, 1520 together at the overlap region 1512 to form the strip 1530. The welder 1570 is a hot air welder and is equivalent to the welder 600 as described in the above.

The strip 1530 is then collected as a roll 1532, which is driven to rotate by drive means 1534. The roll 1532 when full can be removed by cutting the strip 1530. The removed roll can then be attached to the stationary support 230 to form the roll 210 of apparatus 100, as shown in FIG. 1. Alternatively, the rolls 1532, 210 may be dispensed with and the strip 1530 fed directly to the mandrel 300 as the strip 400.

Optionally, the width of the strip 1530 is further increased by repeating the process shown in FIG. 6a, such that two strips 1530 (not shown) are joined to form a wider strip 1536 (not shown).

Typically, a strip of a single roll is about 3.5 cm in width, hence two strips joined together are about 7.0 cm in width, although it will be appreciated that other sized strips may be used.

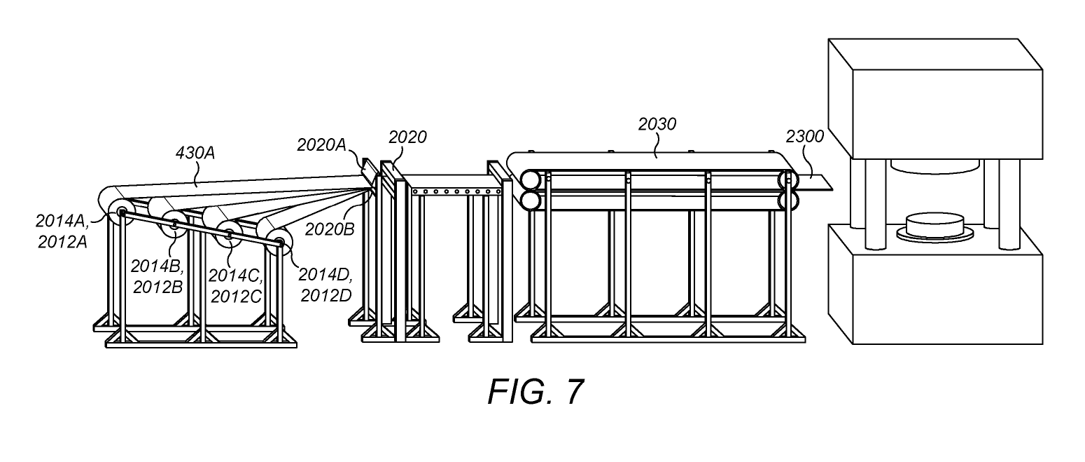

Following the process in accordance to the apparatus 100 of FIG. 1, the strip 430 can be merged with other layers of strip by the process 2000 illustrated in FIG. 7, as will be discussed in more detail below.

Accordingly, with reference to FIG. 7, and as part of the process 2000, two portions of the strip 430A, 430B are arranged to sandwich further portions of strips 2010A, 2010B. In more detail, the strips 430A, 2010A, 2010B and 430B are arranged on respective rolls 2012A, B, C, D. The respective axis of rotation 2014A, B, C, D of the rolls 2012 are aligned to each other and are arranged such: that the axis 2012B is forward of and below the axis 2012A; axis 2012C is forward of and below the axis 2012B; axis 2012D is forward of and below the axis 2012C. In this way the strips 2010A, 430A, 430B, 2010B are fed into a pressing element 2020, such that they can overlay each other.

The pressing element 2020 comprises counter rotating rollers 2020A, 2020B which are arranged to guide and press the strips 2010A, 430A, 430B, 2010B which are fed between them.

Downstream of the pressing element 2020 a curing element 2030 acts to part consolidate the strips 2010A, 430A, 430B, 2010B together. The curing element 2030 may be hot air means as described in the above, or may be an ultrasonic means.

The part consolidated strips 2010A, 430A, 430B, 2010B thereafter comprises a lay-up 2300. The lay-up 2300 can be cut to size and processed to form various composite components by known means.

The strips 2010A, 430A, 430B, 2010B can have various fibre orientations, for instance: the strip 2010A comprises two plies which are 90° and 0°; the strip 2010B comprise two plies which are 0° and 90°; the strip 430A comprises two plies which are 45° and −45°; the strip 430B comprises two plies which are −45° and 45°. In this way a lay-up which is [45/−45/90/0]S is given.

It will also be appreciated that this process 2000 can be used to join various numbers of strips together by the provision of additional rolls 2012.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. An apparatus to form off-axis composite material, the apparatus comprising:
a supply means to operable supply a strip of composite material, the strip comprising a matrix and a plurality of fibres, which are aligned to each other;
a stationary mandrel arranged to receive a portion of the strip from the supply means, the mandrel and supply means being arranged such that the strip is supplied to the mandrel with the fibres orientated off-axis to an elongate axis of the mandrel,
a drive means configured to drive the received strip to rotate about the mandrel, and to move axially along the elongate axis of the mandrel such that the strip forms a tube on the mandrel,
wherein the mandrel is configured to dispense the tube from an end of the mandrel such that the dispensed tube, when pressed into a further strip or sheet, has fibres which have an orientation that is off-axis in relation to the length of the further strip or sheet.

2. (canceled)

3. (canceled)

4. The apparatus of claim 1, wherein the fibres of the supplied strip of material of the supply means are aligned substantially to the length of the strip.

5. The apparatus of claim 1, wherein the angle at which the fibres of the strip of composite material are supplied relative the elongate axis of the mandrel is between 5° to 85°.

6. (canceled)

7. The apparatus of claim 1, wherein a position of a stationary support of the supply means is adjustable such that the angle at which the fibres are supplied relative the elongate axis of the mandrel is adjustable, to thereby adjust the angle of the fibres in the further strip dispensed from the mandrel.

8-14. (canceled)

15. The apparatus of claim 1, wherein the apparatus further comprises a welding element arranged to join a portion of the strip once received on the mandrel to an adjacent portion of strip on the mandrel to thereby form the tube.

16. (canceled)

17. The apparatus of claim 1, wherein the apparatus further comprises a heating element which is disposed proximate the supply means, which is operable to soften the strip once dispensed from the supply means.

18. The apparatus of claim 1, wherein the mandrel comprises a dispensing section for dispensing the tube, and wherein the dispensing section is positioned at a first end of the mandrel, and comprises a tapered section, the taper being arranged such that the diameter of the mandrel is narrower at its tip.

19. The apparatus of claim 18, wherein the apparatus further comprises a receiving means, which is operable to receive the tube once dispensed from the dispensing section of the mandrel, the receiving means comprising a roll which is rotatably mounted to a support structure and rotatable about a rotational axis which is orientated substantially perpendicular to the elongate axis of the mandrel,
wherein the support structure is configured to enable rotation of the roller receiving means about an axis which is substantially aligned to the elongate axis of the mandrel, such that it rotates with the tube to prevent twisting of the tube when dispensed from the dispensing section of the mandrel.

20. The apparatus of claim 19, wherein a cutting element is disposed between the dispensing section of the mandrel and the roller receiving means, which is operable to cut the tube at a first and second point along a line parallel to the axis of rotation of the roller receiving means, wherein the first and second point are diametrically opposed to each other, and wherein an opening element is disposed between the cutting element and roller receiving means, wherein the opening element comprises guide means, which are configured to guide the cut tube to a substantially flat strip prior to it being received by the receiving means.

21. The apparatus of claim 1, wherein the mandrel comprises a cutting section operable to cut the tube into portions of a given length.

22-25. (canceled)

26. The apparatus of claim 21, wherein the apparatus further comprises a flattening section for flattening the portions of tube dispensed by the cutting section, so that a sheet comprising two plies, wherein the angle of the fibres in the first ply is equal and opposite to the angle of the fibres in the second ply, is formed.

27. The apparatus of claim 26, wherein the flattening section comprises a plurality of pairs of rollers, and wherein:
the rollers in each pair are disposed at opposite sides of an elongate axis of the tube,
the rollers are aligned transversely with respect to the axis of the tube,
the rollers in each pair are positioned in the same vertical longitudinal plane, and
the plurality of pairs of rollers are positioned successively from a receiving end, closest to the cutting section, and a dispensing end, furthest from the cutting section, the distance between the rollers in each of the plurality of pairs of rollers decreasing successively from the receiving end to the dispensing end, so that a tube propelled through the flattening section is progressively flattened.

28. (canceled)

29. The apparatus of claim 26, wherein the apparatus comprises a bonding section, operable to bond together a plurality of sheets of composite material dispensed by the flattening section to form a single multi-ply sheet.

30. The apparatus of claim 29, wherein the plies of the plurality of sheets of composite material are arranged so that the orientation of the fibres in the plies from a top ply to a middle ply is identical to the orientation of the fibres in the plies from a bottom ply to a middle ply.

31. (canceled)

32. A method of forming off-axis composite material, the method comprising:
supplying a strip of composite material from a supply means to a stationary mandrel, the strip comprising a matrix and a plurality of fibres, which are aligned to each other, wherein the mandrel and supply means are arranged such that the pre-preg strip is supplied to the mandrel with the fibres orientated off-axis to an elongate axis of the mandrel,
using a drive means to drive the received strip to rotate about the mandrel, and to move axially along the elongate axis of the mandrel such that the pre-preg strip forms a tube on the mandrel;
dispensing the tube from an end of the mandrel such that the dispensed tube when pressed into a strip or sheet has fibres which have an orientation that is off-axis in relation to the length of the strip or sheet.

33. (canceled)

34. (canceled)

35. The method of claim 32, wherein the method includes a step of collecting the dispensed strip as a roll on a receiving means, the roll having an axis of rotation which is oriented substantially perpendicular to the axis of rotation of the mandrel,
wherein the step of collecting the dispensed strip includes a step of rotating the roll about an axis aligned to the elongate axis of the mandrel by means of a rotatable support structure.

36. The method of claim 35, wherein the method further comprises a step of laying one or more further strips with the strip of the roller of the receiving means to form a composite lay-up, the method comprising:
arranging a roll of the or each further strip adjacent a roll from the receiving roller, such that the strip from the receiving roller and the or each further strip when dispensed are laid together when received by a pressing element, the pressing element preferably comprising a plurality of rollers,
wherein the or each further strip comprises strip material arranged with the fibres orientated differently to the fibres of the strip from the receiving roller.

37. The method of claim 32, wherein the method includes a step of cutting the tube into sections using a cutting section.

38. The method of claim 37, wherein the method includes a step of flattening the cut sections of tube to form sheets having fibres which have an orientation that is off-axis in relation to the length of the strip or sheet.

39. (canceled)

40. (canceled)

41. The apparatus of claim 27, wherein the apparatus comprises a bonding section, operable to bond together a plurality of sheets of composite material dispensed by the flattening section to form a single multi-ply sheet.
